(19) United States
(12) Patent Application Publication
(10) Pub. No.: US 2026/0302557 A1
(43) Pub. Date: Oct. 1, 2026

(54) COMPACT DESIGN FOR MULTIPLE FOIL TAB BATTERY

(71) Applicant: Microsoft Technology Licensing, LLC, Redmond, WA (US)

(72) Inventor: Wei LI, Shenzhen (CN)

(21) Appl. No.: 19/478,620

(22) PCT Filed: Jun. 12, 2023
(86) PCT No.: PCT/CN2023/099617

§ 371 Date: Oct. 24, 2025

(51) Int. Cl. H01M 50/538; H01M 10/04; H01M 50/528; H01M 50/533; H01M 50/536; H01M 50/553

(52) U.S. Cl. CPC H01M 50/538; H01M 10/0431; H01M 10/0459; H01M 50/528; H01M 50/533; H01M 50/536; H01M 50/553

(57) ABSTRACT

A multiple foil tab battery cell includes a jelly roll structure formed by coiling a multi-layer stack between a first end and a second end. The multi-layer stack includes an anode layer and a first subset of foil tabs extending from the anode layer that are electrically coupled together at a first coupling point. The multi-layer stack further includes a cathode layer and a second subset of foil tabs extending from the cathode layer that are electrically coupled together at a second coupling point. Lead tabs serve as terminal of the battery cell and are coupled to the jelly roll structure at locations physically separated from the first coupling point and the second coupling point.

### BACKGROUND

Battery energy density increases in proportion to the size of battery electrodes. However, modern batteries include some components that occupy physical area in addition to electrodes. The compact designs of increasingly smaller electronic devices drive demand for more compact batteries with higher energy densities.

### BRIEF DESCRIPTIONS OF THE DRAWINGS

FIG. 1 illustrates a manufacturing step of forming a multiple foil tab battery cell implementing the disclosed technology.

FIG. 2 illustrates example layers of a multi-layer stack usable to create a multiple foil tab battery cell implementing the disclosed technology.

FIG. 3A illustrates a perspective view of exemplary components of a multiple foil tab battery cell.

FIG. 3B depicts a cross-sectional region of the components of the multiple foil tab battery cell of FIG. 3A.

FIG. 3C illustrates a cross-sectional region of a complete multiple foil battery cell including the example components shown in FIGS. 3A and 3B.

FIG. 3D depicts a perspective view of the complete multiple foil tab battery cell shown in FIG. 3C.

FIG. 4A illustrates aspects of another example multiple foil tab battery cell.

FIG. 4B depicts a cross-sectional region of the multiple foil tab battery cell of FIG. 4A.

FIG. 5A illustrates a perspective view of another example multiple foil tab battery cell with a jelly roll structure.

FIG. 5B depicts a cross-sectional region of the multiple foil tab battery cell shown in FIG. 5A.

FIG. 6 illustrates example operations for assembling a multiple foil tab battery cell.

### SUMMARY

A method of forming a multiple foil tab battery cell includes electrically coupling, at a first coupling point, a first subset of foil tabs extending from a first electrode layer and electrically coupling, at a second coupling point, a second subset of foil tabs extending from a second electrode layer. The method further includes electrically coupling different lead tabs to each of the first electrode layer and the second electrode layer at locations physically separated from the first coupling point and the second coupling point.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### DETAILED DESCRIPTION

Various battery designs included thin, stacked layers of electrode material. To reduce manufacturing complexity and costs, many popular designs utilize winding and/or folding techniques to create a multi-layered stack instead of stacked separate layers of material. The result is a folded (e.g., zig-zag) or spiral (e.g., jelly roll) shape that includes multiple layers of positive electrode and multiple layers of negative electrode. In some of these battery cells, foil tabs are used to connect the different layers of each individual electrode to one another, such as to connect different electrode layers in series (e.g., if there is no layer-to-layer connection across stack folds) or to connect different sections of an electrode in parallel, reducing battery impedance.

In battery cells that use these foil tabs (referred to herein as “multiple foil tab” batteries), each group of interconnected foil tabs is physically connected to a lead tab that serves as a terminal for a corresponding electrode. In these designs, the tab-to-tab connections impose geometrical constraints that limit the minimum thickness of the battery and also consume length within the pouch encasing the battery. These designs limit the achievable energy density of a battery with fixed dimensions.

The disclosed technology includes a compact design for a multiple foil tab battery that increases the attainable energy density for a fixed-dimension battery cell as compared to existing multiple foil tab battery designs. In the disclosed designs, gains in energy density are realized by coupling the lead tabs of the battery to electrode locations that are physically separated from weld joints connecting groups of foil tabs. Throughout the following description, the term “tab” refers to a bendable, electrically conductive battery component. Different types of tabs serve different functions-specifically, “foil tabs” function to interconnect different folded portions of an electrode while “lead tabs” serve as battery terminals to deliver current to a circuit external to the battery.

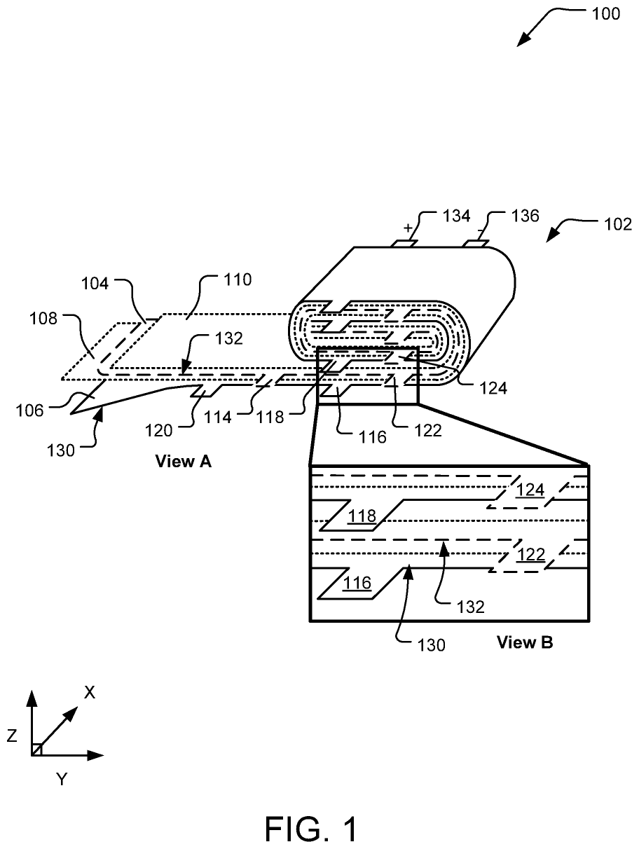

FIG. 1 illustrates a manufacturing step of forming a multiple foil tab battery cell 100 implementing the disclosed technology. The multiple foil tab battery cell 100 is constructed as a multi-layer stack 102 that is then bent multiple times, creating folded or rolled structure. In the illustrated design, the multi-layer stack 102 is rolled from end to end, creating a spiral structure commonly referred to as a “jelly roll.”

In various implementations, the multi-layer stack 102 may include different layers depending upon the type of enclosure (e.g., coil cell, prismatic, pouch, cylinder) that the multiple foil tab battery cell 100 is placed into. The multi-layer stack 102 includes a first electrode layer 104 serving as the cathode, a second electrode layer 106 service as the anode, and separator layers 108, 110 that prevent physical contact between the first electrode layer 104 and the second electrode layer 106.

Due to the rolling or folding of the multi-layer stack 102, the multi-layer stack is folded back over itself multiple times, dividing each of the layers into the stack into stacked sections. The resulting folded or rolled structure (e.g., a jelly roll structure in FIG. 1) includes a cross section that intersects each individual layer of the multi-layered stack 102 multiple times. In the illustrated design, the first electrode layer 104 and the second electrode layer 106 each include a collection of foil tabs that extend from the corresponding layer and protrude from one end of the multiple foil tab battery cell 100.

View B illustrates a section of the multiple foil tab battery cell 100 with the foil tabs shown in greater detail. From both of views A and B, it can be seen that the first electrode layer 104 includes a first set of foil tabs (e.g., foil tabs 118, 124) protruding from a first edge 130 of the multiple foil tab battery cell 100 while the electrode layer 106 includes a second set of foil tabs 120, 122, 124, etc. extending from a corresponding edge 132 of the multiple foil tab battery cell 100. The first set of foil tabs and the second set of foil tabs each extend from a same end of the multiple foil tab battery cell 100, with the tabs extending in a direction substantially parallel to a folding or rolling axis.

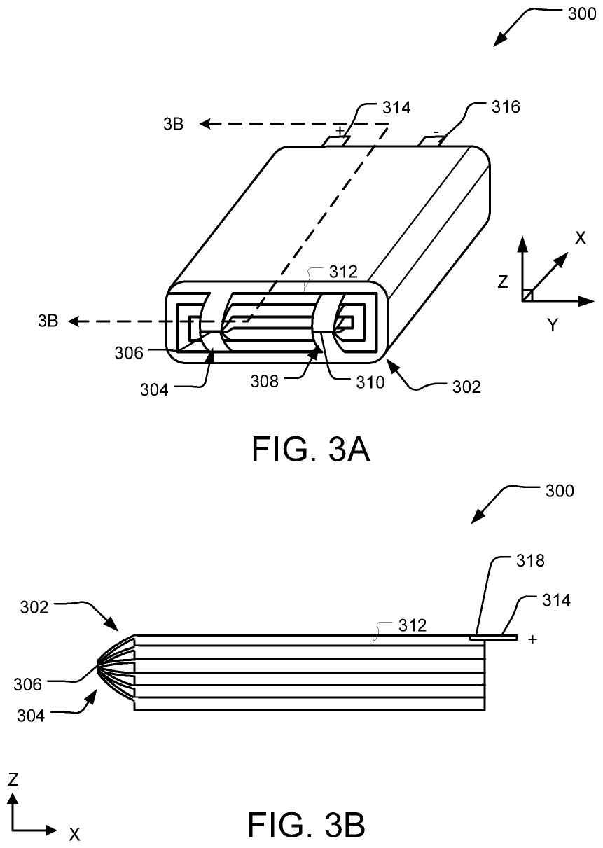

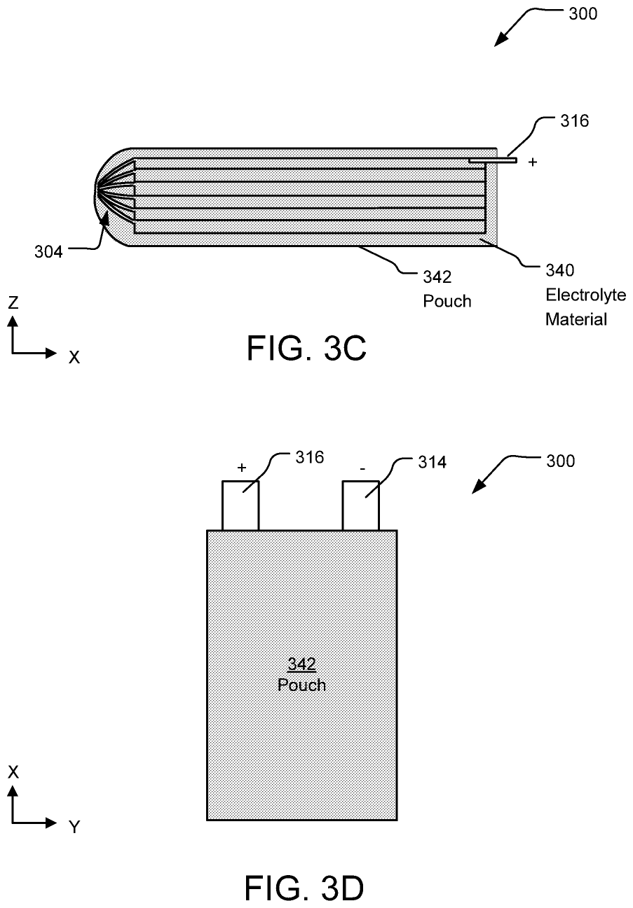

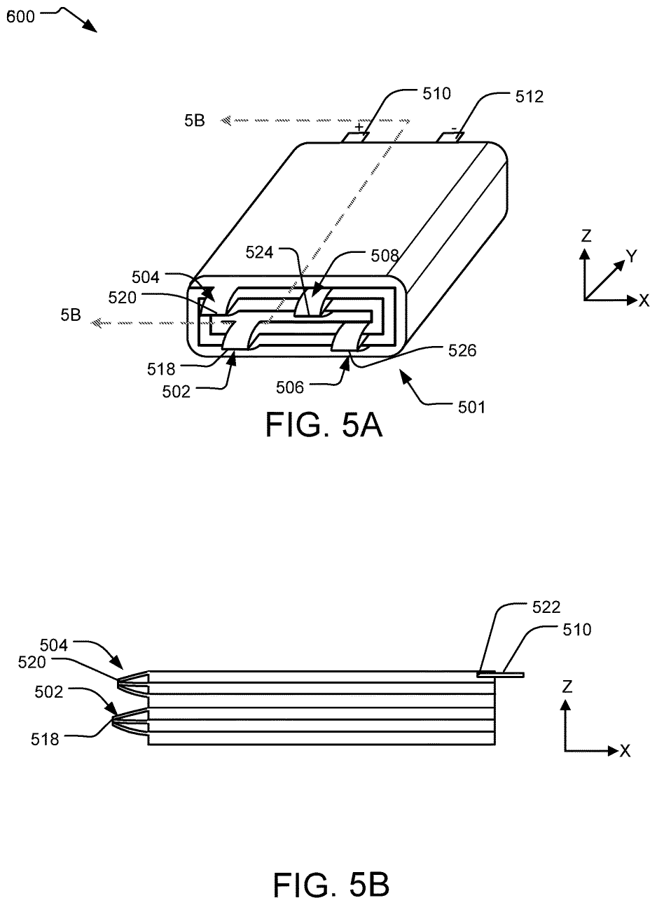

After the rolling step illustrated in FIG. 1, the first set of foil tabs 114, 116, 118, etc. of the first electrode layer 104 are folded toward one another (e.g., toward a center of the stack) and electrically coupled together at a first coupling location, such as by welding, soldering, or adjoining by other electrically conductive adhesive. Likewise, the second set of foil tabs 120, 122, 124, etc. of the second electrode layer are folded toward one another and electrically coupled together at a second coupling location. Examples of foil tab couplings are shown in FIGS. 3A, 3B, 5A, and 5B, as discussed further below.

The purpose of the foil tabs is to facilitate couplings between the different folded portions of the electrode layer 104 and between the different folded portions of the electrode layer 106. Without these foil tab couplings, the folded portions of each of individual electrode layer (e.g., 104, 106) are connected in series; however, with these foil tab couplings, the folded portions of each individual electrode layer are effective connected in parallel-providing a shortened electron and heat conductivity path within each electrode layer that decreases overall battery impedance.

In addition to the first set of foil tabs (e.g., foil tabs 114, 116, 118) and the second set of foil tabs (e.g., the foil tabs 120, 122, and 124), the multiple foil tab battery cell 100 also includes lead tabs 134, 136 that serve as battery terminals that conduct current to and from the multiple foil battery cell 100, to power external device(s). The lead tabs 134, 134 are thin strips of metal electrically coupled to a corresponding one of the first electrode layer 104 and the second electrode layer 106.

In common (existing) multiple foil battery designs, each of the lead tabs 134, 136 is electrically coupled (e.g., welding) to all foil tabs attached to a same electrode layer. In some stacked configurations where the different sections of each are physically separate from one another (e.g., they are not connected in series across folds of the electrode material), it is necessary to couple the lead tab to the foil tabs.

However, one consequence of coupling the lead tabs to the foil tabs is that the resulting interconnected structure is somewhat bulky in form due to geometrical limitations that arise in relation to physically connecting so many different tabs to a common location. These physical limitations include a minimum layer-to-layer separation within the Z-height of the multi-layer stack 102 to ensure sufficient room to bend the tabs toward one another in the Z-plane as well as additional length in the x-direction to accommodate the somewhat large size of a weld joint that is needed to ensure sufficient electrical connection between the lead tabs and the foil tabs.

In additional to the above-mentioned undesirable geometrical constraints, this previous approach requires two welding steps that must be performed sequentially—e.g., a first welding step to connect together the foil tabs and a second welding step to connect each lead tab to a corresponding group of foil tabs. The secondary weld step in this approach requires a precise alignment between the foil tab weld and subsequent weld to the lead tab, which is typically done using a specially-purposed machine. This complicates the assembly line process.

In contrast, the presently disclosed designs include the lead tabs 134, 136 (e.g., battery terminals) on a different end of the multiple foil tab battery cell 100 as compared to the sets of coupled foil tabs. There are several advantages to this design difference. First, this design simplifies the assembly line process by relaxing the tight alignment requirements in previous designs (e.g., since two weld joints do not need to be formed on top of one another) and also speeds manufacturing since the welding of the foil tabs and the lead tabs can be done without using a specially-purposed machine. Additionally, this allows for a more compact overall geometry. Consequently, a battery of fixed dimensions can, with the disclosed design, have larger electrodes and higher energy density than previous multiple foil tab battery cells of the same fixed dimensions.

The disclosed multiple foil tab battery cell designs may be implemented in a variety of different types of batteries, including lithium ion, and nickel metal hydride (NiHM), some of which include “folded” layer structures instead of the jelly roll illustrated FIG. 1.

In one implementation where the multiple foil battery cell 100 is a lithium ion battery cell, the first electrode layer 104 includes a positively-charged current collection foil, such as aluminum, coated with lithium oxide. The second electrode layer 106 includes a negatively-charged current collection foil, such as copper coated with graphite. The separator layers 108, 110 function as physical barriers to keep the cathode and anode materials apart while being permeable to lithium ions.

In a lithium ion battery, the multiple foil tab battery cell 102 is placed into a pouch filled with an electrolyte material. During a discharge cycle, lithium atoms in the anode are ionized and separated from their electrons. The lithium ions move from the anode (e.g., the electrode layer 104) and pass through the electrolyte material until they reach the cathode (e.g., the electrode layer 106), where they recombine with electrons and electrically neutralize.

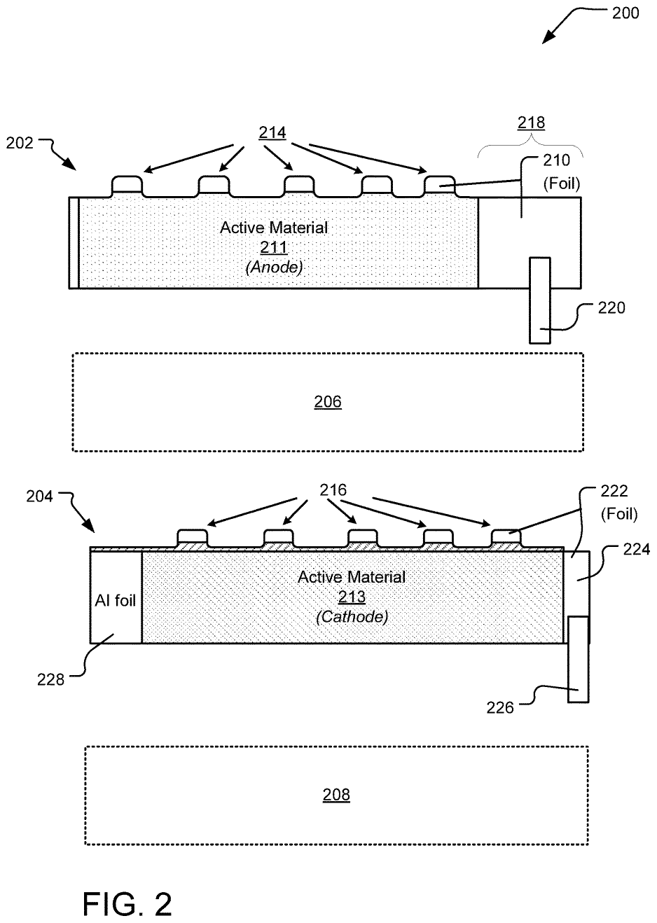

FIG. 2 illustrates example layers of a multi-layer stack 200 usable to create a multiple foil tab battery cell implementing the disclosed technology. The multilayer stack includes two electrode layers—e.g., an anode layer 202 and a cathode layer 204—as well as two separator layers 206, 208. In one implementation, these layers are stacked in the order shown (e.g., from top to bottom) while oriented substantially as shown with the foil tabs 214 and 216 extending from a same edge of the stack.

In one implementation, the anode layer 202 is formed of a thin (e.g., 4.5-20 micrometer nm) negatively-charged foil (e.g., foil 210), such as a copper substrate, that includes a first set of tabs 214 extending from one edge substantially parallel to a long axis of the foil 210. An active material 211, such as graphite is deposited on a first side of the foil 210, coating a large central portion along the length of the foil 210 while leaving the foil 210 exposed in some regions, including the first set of tabs 214 and an end portion 218 of the foil 210. A first lead tab 220 is electrically coupled to the end portion 218 of the foil 210 where there is no active material.

The cathode layer 204 is formed of a thin (e.g., 8 to 20 microns) positively-charged foil (e.g., foil 222) that includes a second of tabs 216 extending from one edge substantially parallel to a long axis of the foil 222. In one implementation, the foil 222 is an aluminum substrate. Another active material 213 containing lithium ions is deposited on a first side of the foil 222, coating substantially the entire length of the foil 222 in except for the second set of tabs 216 and end portions 224, 228 of the foil 222, which remain exposed in the illustrated implementation. In other implementations, the active material 213 extends all the way one to one or both ends of the foil 222 so as to coat one or both of the end portions 224, 228. A second lead tab 226 is electrically coupled to the end portion 218 of the foil 210 where there is no active material.

The separator layers 206, 208 are thin (e.g., 7 to 20 microns) layers that are permeable to ions but not electrons. Example materials that may be used to form the separator layers 108, 110 include synthetic resins such as polyethylene (PE) or polypropylene (PP).

In various designs, there exist variations in both the number of the foil tabs and the spacings between the foil tabs extending from each of the anode layer 202 and the cathode layer 204. In one implementation, the foil tabs of a given electrode layer (e.g., the foil tabs 214 or the foil tabs 216) are spaced relative to one another such there exists a single foil tab corresponding to each different folded section of the resulting battery cell with some or all tabs of the electrode layer being aligned in the z-direction of the resulting battery structure, as shown in FIG. 3 (discussed below).

FIG. 3A and FIG. 3B illustrates views of example components of a multiple foil tab battery cell 300 implementing the disclosed technology. In one implementation, the multiple foil tab battery cell 300 is formed by first stacking the layers illustrated in FIG. 2 and subsequently rolling the resulting stacked structure from end-to-end, creating a jelly roll structure 302 that is similar to that shown in FIG. 1. For simplicity of illustration, the jelly roll structure 302 illustrates all layers of the original stack (e.g., electrode layers and separation layers) as a combined single layer (e.g., layer 312) that coils back around itself multiple times. Notably, some battery cells implementing the disclosed multiple foil tab architecture do not have the jelly roll structure 302 but are instead folded in other configurations, such as alternating folds in different directions (e.g., a zig-zag structure).

As shown, the multiple foil tab battery cell 300 is not yet a fully functioning battery. Prior to shipping the product for use, the multiple foil tab battery cell 300 is placed into a pouch filled with an electrolyte. This pouch is omitted from FIG. 3 for better illustration of the features of the multiple foil tab battery cell 300.

A perspective view shown in FIG. 3A depicts a first set of foil tabs 304 and a second set of foil tabs 308 extending from locations visible on a first end of the jelly roll structure 302. The first set of foil tabs 304 are electrically coupled together at a first coupling point 306 while the second set of foil tabs 308 are electrically coupled together at a second coupling point 310. Each tab of the first subset of foil tabs 304 extends from an edge of a first electrode layer (e.g., an anode layer) while each tab of the second subset of foil tabs 308 extends from a corresponding edge of a second electrode layer (e.g., a cathode layer), such as in a manner consistent with the placement and orientation of layers shown in FIG. 2.

By design, the foil tabs 304 of the first subset are spaced to ensure that each tab extends from a different folded section of the corresponding electrode layer within of the jelly roll structure 302 and all tabs of each individual subset are substantially aligned in the z-direction (e.g., defining the thickness of the battery cell) of the jelly roll structure 302. Consequently, each of the subsets of the foil tabs 304 and 308 can be bent toward one another—e.g., toward a center of the cell—and permanently attached, such as by welding, soldering, conductive adhesive, or other electrical coupling method, as generally shown. For example, the foil tabs of the first subset 304 are bent toward the z-direction center of the jelly roll structure 302 and welded together at the first coupling point 306.

The multiple foil tab battery cell 300 includes lead tabs 314, 318 that extend from an opposite end of the jelly roll structure 302 than the subsets of foil tabs. The lead tab 314 functions as a positive battery terminal while the lead tab 318 functions as a negative battery terminal.

FIG. 3B depicts a cross-sectional region of the components of the multiple foil tab battery cell 300 shown in FIG. 3A. The cross-sectional region shown in FIG. 3B is denoted by the dotted line in FIG. 3A. In this view, it can be seen that the lead tab 314 is straight (not bent) and electrically coupled to the multiple foil tab battery cell 300 at a third coupling point 318 that is physically separated from the coupling points 306 and 310 of the foil tabs located at the opposite end of the battery cell. In one implementation, the position of the lead tab 314 along the length of folded electrode layer within the jelly roll structure 302 corresponds to that of the lead tab 220 of FIG. 2.

Although not visible in the cross sectional view of FIG. 3B, the lead tab 316 is electrically coupled to the multiple foil tab battery cell 300 at a fourth coupling point similar but physically separated from the location to the third coupling point 314. Notably, the lead tab 316 and the lead tab 314 are electrically coupled to different electrode layers included within layer 312 of the jelly roll structure 302, such as at locations corresponding to those of the lead tabs 220 and 226 in FIG. 2.

Notably, the first coupling point 306 and the second coupling point 318 of the foil tabs are positioned on a first end of the multiple foil tab battery cell 300 that is opposite an end of the multiple foil tab battery cell 300 supporting the third coupling point 318 and the fourth coupling point (not shown) of the lead tabs 314 and 316. This physical separation between the lead tabs and the foil tabs facilitates a reduction in the overall dimensions of the battery cell due, in part, to the fact that each of the lead tabs 314 and 316 is welded directly to a corresponding electrode layer within the jelly roll structure 302 rather than being welded to another, previously-formed weld joint connecting a group of foil tabs (e.g., eliminating need for a particularly large weld joint to provide a sufficient structural connection).

FIGS. 3C and 3D illustrate the above-described example components of the multiple foil tab battery cell 300 shown inside of a pouch 342 that is filled with electrolyte material 340. FIG. 3C illustrates a cross sectional view taken from the same perspective as FIG. 3B (illustrating the positioning of lead tab 316 relative to the first set of foil tabs 304), while FIG. 3D illustrates a top-down view of the multiple foil tab battery cell 300 with the jelly roll structure 302 positioned within the pouch 342 with the lead tabs 314 and 316 exposed. In the view of FIG. 3D, the two sets of foil tabs (e.g., 304 and 308 in FIG. 3A) are not visible because they are located inside of the pouch 342.

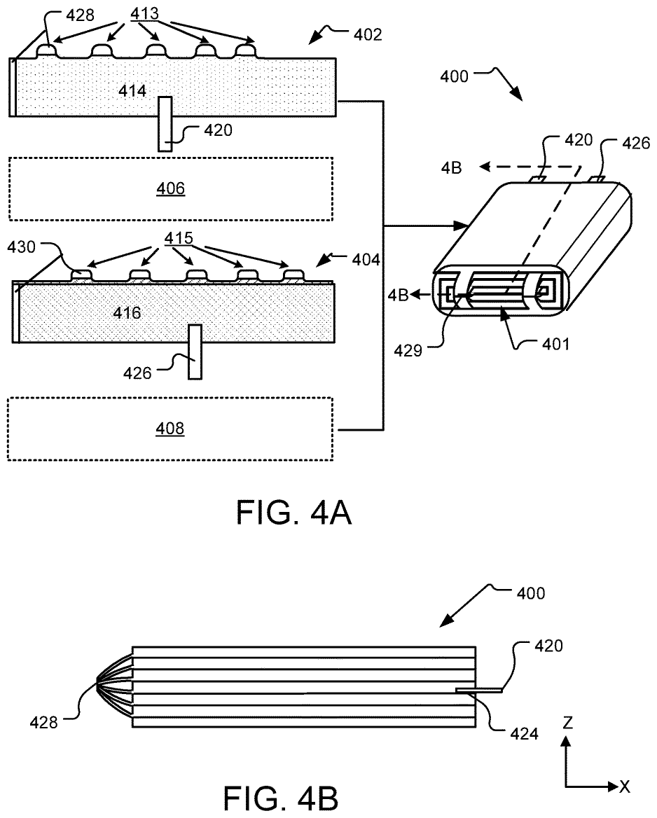

FIG. 4A illustrates aspects of another example multiple foil tab battery cell 400. Like the battery cell shown in FIG. 3, the multiple foil tab battery cell 400 is formed by creating a multi-layer stack and then rolling the multi-layer stack from end to end to create a jelly roll structure 401. The multi-layer stack includes electrode layers 402 and 404 interleaved between separation layers 406, 408. Features of these layers not described explicitly with respect to FIG. 4A or 4B are, in various implementations, the same or similar as those described above with respect to any of FIGS. 2, 3A, and 3B.

A key design difference between the multiple foil tab battery cell 400 and the battery cells depicted with respect to FIGS. 2, 3A, and 3B is the placement of lead tabs 420, 426. In FIG. 4A, the lead tabs 420, 426 are each shown electrically coupled to a central region of the corresponding electrode layer 402, 404 rather than to a location proximal to an end of the corresponding electrode layer 402 or 404. To facilitate these couplings of the lead tabs 420, 426, a small patch of active material (e.g., active material 414, 416) is removed to expose bare foil (e.g., foil substrates 428, 430) in a region where the corresponding one of the lead tabs 420, 426 is to be attached. For example, a small patch of the active material 414 is removed exposing an underlying portion of the foil substrate 428, and the lead tab 420 is then welded onto this exposed area of the foil substrate 428 such that it is no longer visible. This placement of the lead tabs 420, 426 toward the center of the electrode layers (e.g., at a position between a pair of the foil tabs 413 or 415) may allow for a larger total surface area of the active material on each electrode layer as compared to the implementation of FIG. 2, effectively increasing the energy density of a battery cell with fixed dimensions.

FIG. 4B depicts a cross-sectional region of the multiple foil tab battery cell 400. The cross-sectional region depicted is denoted by the dotted line in FIG. 4A. In this view, it can be seen that the lead tab 420 is electrically coupled to the multiple foil tab battery cell 400 at a coupling point 424 that appears to be located near a center of the jelly roll structure 401 and at the opposite end of the battery cell as compared to a coupling point 429 of foil tabs protruding from the electrode layer 402.

FIG. 5A illustrates a perspective view of yet another example multiple foil tab battery cell 500 with a jelly roll structure 501. FIG. 5B depicts a cross-sectional region of the multiple foil tab battery cell 500 denoted by the dotted line in FIG. 5A. Like other battery cells described herein, the multiple foil tab battery cell 500 is formed by creating a multi-layer stack including electrode layers interleaved between separation layers, in the order generally depicted by FIG. 2 and FIG. 4B. The multi-layer stack is then rolled from end to end (e.g., as shown with respect to FIG. 1).

In the implementation of FIG. 5A-5B, multiple distinct groups of interconnected foil tabs are shown extending from different locations visible on a first end of the multiple foil tab battery cell 500. In one implementation, the multiple foil tab battery cell 500 includes an anode layer and the cathode layer that each include a conductive foil substrate coated with a different active material, as described with respect to FIG. 2. Each of these conductive foils includes exposed (bare) foil tabs extending from a first edge. The implementation of FIG. 5A-5B differs from other implementations described herein in that the spacing of the foil tabs along each edge is carefully selected to ensure z-direction alignment in the resulting jelly roll structure between multiple distinct groups of the foil tabs protruding from each of the anode layer and the cathode layer.

To exemplify this concept, FIGS. 5A and 5B illustrate a first subset 502 and a second subset 504 of foil tabs extending from a portion of the multiple foil tab battery cell 500 that, in one implementation, corresponds to the anode layer. The tabs of the first subset 502 are bent toward one another and electrically coupled (e.g., welded) at a first coupling point 518. The tabs of the second subset 504 are bent toward one another and electrically coupled at a second coupling point 520.

Although not visible in the cross-sectional view of 5B, the perspective view of FIG. 5A further illustrates a third subset 506 and a fourth subset 508 of foil tabs extending from portions of the multiple foil tab battery cell 500 that, in one implementation, correspond to the cathode layer. The tabs of the third subset 506 are bent toward one another and electrically coupled at a third coupling point 524, while the tabs of the fourth subset 508 are bent toward one another and electrically coupled at a fourth coupling point 526.

The multiple foil tab battery cell 500 also includes lead tabs 510, 512 that serve as battery terminals. The lead tabs 510, 512 are electrically coupled to an end of the multiple foil tab battery cell 500 that is opposite the end including the various groups of foil tabs. The lead tab 510 is electrically coupled, at a fifth coupling point 522 (shown in FIG. 5B), to an edge of an anode layer that is opposite the edge from which the foil tabs of the anode layer extend. Likewise, the lead tab 512 is electrically, at a sixth coupling point (not shown) to an edge of the cathode layer opposite the edge from which the foil tabs of the cathode layer extend.

In existing (previous) designs where all foil tabs of a same electrode layer are coupled at a common location, the average bend distance for each tab grows in proportion to the z-direction thickness of the jelly roll structure 501. This creates structural challenges when coupling the foil tabs together. The design of FIG. 5A-5B eliminates these challenges by instead coupling together, at different coupling points, different subsets of the foil tabs attached to each electrode layer. Consequently, this technique can be used to create battery cells with a much greater z-direction thickness than is common in battery cells employing multiple foil tab designs today, effectively extending the usage of multiple foil battery designs to larger batteries with considerably higher energy densities. It is to be appreciated that in various implementations, the foil tabs of each electrode layer can be grouped into any number of independently-coupled tab subsets.

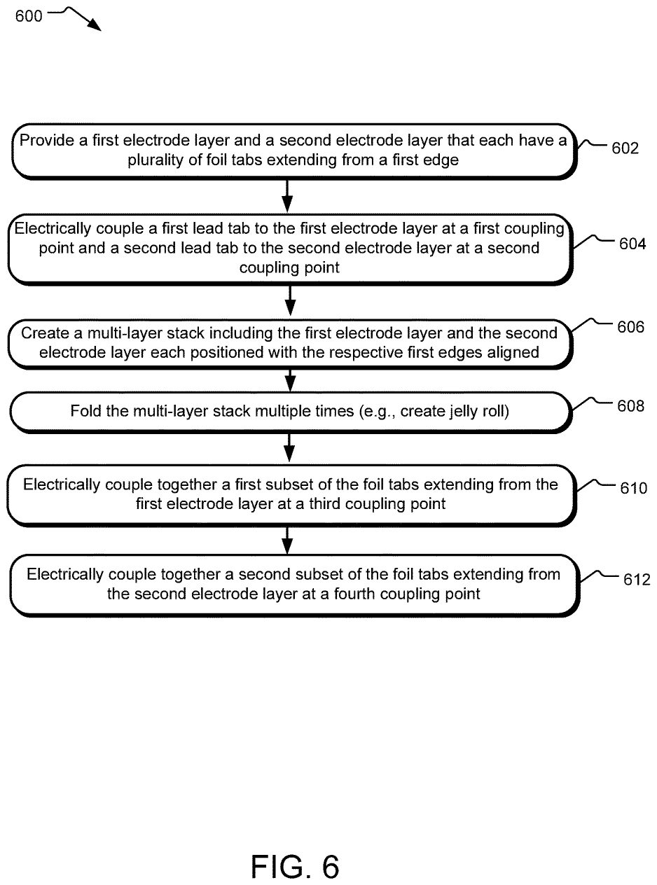

FIG. 6 illustrates example operations for forming a compact multiple foil tab battery cell. A providing operation 602 provides a first electrode layer and a second electrode layer that each include a plurality of foil tabs extending from a first edge. In one implementation, the first electrode layer includes a negatively-charged conductive foil (e.g., copper) and the second electrode layer includes a positively-charge conductive foil (e.g., aluminum). Both the negatively-charged conductive foil and the positively-charged conductive foil include a central region coated with different types of active material. The active material does not coat the foil tabs of either the first electrode layer or the second electrode layer.

An electrical coupling operation 604 electrically couples a first lead tab to the first electrode layer at a first coupling point and a second lead tab to the second electrode layer at a second coupling point. In one implementation, the first lead tab and the second lead tab are coupled to exposed (bare) regions of the conductive foil within the corresponding electrode layer.

In various implementations described and shown herein, the lead tabs are each coupled to an edge of an electrode layer that is opposite the include the foil tabs. However, the positioning of the lead tabs and foil tabs on opposite ends of the battery cell is not critical to practicing the disclosed technology. In some implementations, the lead tabs extend from the same end of the battery cell as the foil tabs. A key commonality of all such implementations of the disclosed technology is the fact that the lead tabs are not coupled to the foil tabs or to the respective coupling points that connect the foil tabs together. This simplifies the mechanical architecture of the battery and reduces the spatial footprint of the lead tabs.

In one implementation, the lead tabs are coupled to the electrode layers before the layers are stacked and rolled (e.g., before creation of a jelly roll structure as shown in FIG. 1). This simplifies manufacturing due to the fact that the lead tabs can be attached to the corresponding foil sheets without tight alignment restrictions due, in part, to the fact that the exposed foil sheet surface area is several times larger than the area of the foil tabs where the lead tabs. When, in contrast, the lead tabs are attached to the foil tabs after creation of the jelly roll structure (as in previous multiple foil tab cell designs), a more precise alignment is typically required due to the smaller surface area of the foil tabs serving as the weld location. In the former scenario with more relaxed positioning requirements, ultrasonic welding can be used while the latter scenario with more stringent positioning requirements may require a different type of welding, such as laser welding. Notably, ultrasonic welding is often preferred in applications where speed it important because ultrasonic welding can produce a very strong bond in a very short period of time, such as a few seconds. In contrast to ultrasonic welding, laser welding take longer to create a weld joint and relies on more expensive equipment.

A stack creation operation 606 creates a multi-layer stack including at least the first electrode layer and the second electrode layer each positioned with their respective first edges aligned such that the foil tabs of the first electrode layer extend from a same edge of the multi-layer stack as the foil tabs of the second electrode layer.

A folding operation 608 folds the multi-layer stack over on itself multiple times, either in a same direction (e.g., rolling to create a jelly roll structure) or otherwise, such as alternating directions to create a zig-zag pattern.

An electrical coupling operation 610 electrically couples together a first subset of the foil tabs extending from the first electrode layer at a third coupling point, and another electrical coupling operation 612 electrically couples together a second subset of the foil tabs extending from the second electrode layer at a fourth coupling point. The third coupling point and the fourth coupling point are physically separated from each other and also from the first coupling point and the second coupling point.

In some aspects, the techniques described herein relate to a method of forming a battery cell including: forming a multi-layer stack including a first electrode layer and a second electrode layer, the multi-layer stack being folded multiple times; electrically coupling, at a first coupling point, a first subset of foil tabs extending from the first electrode layer; electrically coupling, at a second coupling point, a second subset of foil tabs extending from the second electrode layer; and electrically coupling lead tabs to the battery cell at locations physically separated from the first coupling point and the second coupling point, the lead tabs serving as terminals of the battery cell. Coupling the lead tabs to locations separate from the foil tabs reduces manufacturing complexity and can facilitate an increase in battery energy density as compared to same-sized cell designs that couple the lead tabs to the foil tabs.

In some aspects, the techniques described herein relate to a method, wherein electrically coupling the lead tabs is performed prior to forming the multi-layer stack and further includes electrically coupling first lead tab to the first electrode layer and a second lead tab to the second electrode layer. Coupling the lead tabs to a foil sheet prior to forming the multi-layer stack (e.g., including the foil sheet) relaxes alignment requirements as compared to approaches that attach the lead tabs to the battery cell after the multi-layer battery stack is assembled and rolled or folded into its final form factor. Due to these relaxed alignment requirements, ultrasonic welding can be used in lieu of laser welding while reducing manufacturing time and overall cost.

In some aspects, the techniques described herein relate to a method, wherein the first coupling point and the second coupling point are on a first end of the battery cell and the lead tabs extend from a second end of the battery cell opposite the first end. This configuration

In some aspects, the techniques described herein relate to a method, further including: electrically coupling a third subset of foil tabs extending from the first electrode layer of the multi-layer stack at a third coupling point; and electrically coupling a fourth subset of foil tabs extending from the second electrode layer of the multi-layer stack at a fourth coupling point, the third coupling point and the fourth coupling point being located on a same side of the battery cell as the first coupling point and the second coupling point. The use of multiple different sets of foil tabs in association with different portions of each electrode layer (e.g., as shown and described with respect to FIG. 4A) can allow for creation of a thicker battery cell with higher energy density than battery cells of other designs. This benefit arises from the use of multiple physically separated weld locations instead of a single weld location. The use of a single weld location constrains the total number of tabs that can be interconnected due to complexity in creating a weld joint large enough and strong enough to attach a large number of tabs and also due to geometrical constraints arising from the need to “fold” so many tabs toward a common coupling point.

In some aspects, the techniques described herein relate to a method, wherein the multi-layer stack includes at least one separator layer interleaved between the first electrode layer and the second electrode layer and the multi-layer stack is rolled to form a jelly roll structure.

In some aspects, the techniques described herein relate to a method, wherein electrically coupling the first subset of foil tabs includes bending tabs toward one another and welding the tabs together.

In some aspects, the techniques described herein relate to a method, wherein electrically coupling the lead tabs to the battery cell further includes: coupling a first lead tab to the first electrode layer at a third coupling point, the first lead tab serving as a negative terminal of the battery cell; and electrically coupling a second lead tab to the second electrode layer at a fourth coupling point, the second lead tab serving as a positive terminal of the battery cell.

In some aspects, the techniques described herein relate to a method, wherein the first lead tab and the second lead tab are coupled to a first end of the battery cell that is opposite a second end of the battery cell including the first subset of foil tabs and the second subset of foil tabs.

In some aspects, the techniques described herein relate to a method, wherein the first lead tab is attached to a foil substrate at a first location that is substantially surrounded by a first active material and wherein the second lead tab is attached to a second foil substrate at a second location that is substantially surrounded by a second active material.

In some aspects, the techniques described herein relate to a battery cell including: a jelly roll structure including a multi-layer stack coiled around a first axis between a first end and a second end, the multi-layer stack including at least an anode layer and a cathode layer; a first subset of foil tabs extending from the anode layer, the first subset of foil tabs being electrically coupled together at a first coupling point; a second subset of foil tabs extending from the cathode layer, the second subset of foil tabs being electrically coupled together at a second coupling point; and lead tabs serving as terminals of the battery cell, the lead tabs being coupled to the jelly roll structure at locations physically separated from the first coupling point and the second coupling point.

In some aspects, the techniques described herein relate to a battery cell, wherein the first coupling point and the second coupling point are on a first end of the jelly roll structure and wherein the lead tabs are coupled to a second end of the jelly roll structure opposite the first end.

In some aspects, the techniques described herein relate to a battery cell, further including: a third subset of foil tabs that extend from the anode layer, the third subset of foil tabs being electrically coupled together at a fifth coupling point; and a fourth subset of foil tabs that extend from the cathode layer, the fourth subset of foil tabs being electrically coupled together at a sixth coupling point, the fifth coupling point and the sixth coupling point being on a same side of the jelly roll structure as the first coupling point and the second coupling point.

In some aspects, the techniques described herein relate to a battery cell, wherein the lead tabs are coupled to a first side of the jelly roll structure and wherein the first subset of foil tabs, the second subset of foil tabs, the third subset of foil tabs, and the fourth subset of foil tabs all extend from a second side of the jelly roll structure opposite the first side.

In some aspects, the techniques described herein relate to a battery cell, wherein the multi-layer stack includes at least one separator layer interleaved between the anode layer and the cathode layer.

In some aspects, the techniques described herein relate to a battery cell, wherein the first coupling point and the second coupling point are weld joints.

In some aspects, the techniques described herein relate to a battery cell, wherein the lead tabs include: a first lead tab coupled to the anode layer at a third coupling point, the first lead tab serving as a negative terminal of the battery cell; and a second lead tab coupled to the cathode layer at a fourth coupling point, the second lead tab serving as a positive terminal of the battery cell.

In some aspects, the techniques described herein relate to a battery cell, wherein the first lead tab is attached to the anode layer proximal to the first end of the multi-layer stack and the second lead tab is attached to the cathode layer proximal to the first end of the multi-layer stack.

In some aspects, the techniques described herein relate to a battery cell, wherein the first lead tab is attached to a foil substrate at a first location that is substantially surrounded by a first active material and wherein the second lead tab is attached to a second foil substrate at a second location that is substantially surrounded by a second active material.

In some aspects, the techniques described herein relate to a battery cell including: a jelly roll structure including a multi-layer stack coiled between a first end and a second end, the multi-layer stack including at least an anode layer and a cathode layer; a first subset of foil tabs extending from the anode layer, the first subset of foil tabs being electrically coupled together; a second subset of foil tabs extending from the cathode layer, the second subset of foil tabs being electrically coupled together; and lead tabs serving as terminals of the lithium ion battery cell, the lead tabs extending from an end of the battery cell that is opposite the first subset of foil tabs and the second subset of foil tabs.

In some aspects, the techniques described herein relate to a battery cell, wherein the first subset of foil tabs are adjoined at a first coupling point and the second subset of foil tabs are adjoined at a second coupling point and the battery cell further includes: a third subset of foil tabs extending from the anode layer, the third subset of foil tabs being electrically coupled together at third coupling point separate from the first coupling point; and a fourth subset of foil tabs that extend from the cathode layer, the fourth subset of foil tabs being electrically coupled together at a fourth coupling point separate from the second coupling point.

In some aspects, the techniques described herein relate to a method of forming a battery cell including: a means for forming a multi-layer stack including a first electrode layer and a second electrode layer, the multi-layer stack being folded multiple times; a means for electrically coupling, at a first coupling point, a first subset of foil tabs extending from the first electrode layer; a means for electrically coupling, at a second coupling point, a second subset of foil tabs extending from the second electrode layer; and a means for electrically coupling lead tabs to the battery cell at locations physically separated from the first coupling point and the second coupling point, the lead tabs serving as terminals of the battery cell. Coupling the lead tabs to locations separate from the foil tabs reduces manufacturing complexity and can facilitate an increase in battery energy density as compared to same-sized cell designs that couple the lead tabs to the foil tabs.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method of forming a battery cell comprising:
forming a multi-layer stack including a first electrode layer and a second electrode layer, the multi-layer stack being folded multiple times;
electrically coupling, at a first coupling point, a first subset of foil tabs extending from the first electrode layer;
electrically coupling, at a second coupling point, a second subset of foil tabs extending from the second electrode layer; and
electrically coupling lead tabs to the battery cell at locations physically separated from the first coupling point and the second coupling point, the lead tabs serving as terminals of the battery cell.

2. The method of claim 1, wherein electrically coupling the lead tabs is performed prior to forming the multi-layer stack and further comprises electrically coupling first lead tab to the first electrode layer and a second lead tab to the second electrode layer.

3. The method of claim 1, wherein the first coupling point and the second coupling point are on a first end of the battery cell and the lead tabs extend from a second end of the battery cell opposite the first end.

4. The method of claim 1, further comprising:
electrically coupling a third subset of foil tabs extending from the first electrode layer of the multi-layer stack at a third coupling point; and
electrically coupling a fourth subset of foil tabs extending from the second electrode layer of the multi-layer stack at a fourth coupling point, the third coupling point and the fourth coupling point being located on a same side of the battery cell as the first coupling point and the second coupling point.

5. The method of claim 1, wherein the multi-layer stack includes at least one separator layer interleaved between the first electrode layer and the second electrode layer and the multi-layer stack is rolled to form a jelly roll structure.

6. The method of claim 1, wherein electrically coupling the first subset of foil tabs includes bending tabs toward one another and welding the tabs together.

7. The method of claim 1, wherein electrically coupling the lead tabs to the battery cell further comprises:
coupling a first lead tab to the first electrode layer at a third coupling point, the first lead tab serving as a negative terminal of the battery cell; and
electrically coupling a second lead tab to the second electrode layer at a fourth coupling point, the second lead tab serving as a positive terminal of the battery cell.

8. The method of claim 7, wherein the first lead tab and the second lead tab are coupled to a first end of the battery cell that is opposite a second end of the battery cell including the first subset of foil tabs and the second subset of foil tabs.

9. The method of claim 7, wherein the first lead tab is attached to a foil substrate at a first location that is substantially surrounded by a first active material and wherein the second lead tab is attached to a second foil substrate at a second location that is substantially surrounded by a second active material.

10. A battery cell including:
a jelly roll structure comprising a multi-layer stack coiled around a first axis between a first end and a second end, the multi-layer stack including at least an anode layer and a cathode layer;
a first subset of foil tabs extending from the anode layer, the first subset of foil tabs being electrically coupled together at a first coupling point;
a second subset of foil tabs extending from the cathode layer, the second subset of foil tabs being electrically coupled together at a second coupling point; and
lead tabs serving as terminals of the battery cell, the lead tabs being coupled to the jelly roll structure at locations physically separated from the first coupling point and the second coupling point.

11. The battery cell of claim 10, wherein the first coupling point and the second coupling point are on a first end of the jelly roll structure and wherein the lead tabs are coupled to a second end of the jelly roll structure opposite the first end.

12. The battery cell of claim 10, further comprising:
a third subset of foil tabs that extend from the anode layer, the third subset of foil tabs being electrically coupled together at a fifth coupling point; and
a fourth subset of foil tabs that extend from the cathode layer, the fourth subset of foil tabs being electrically coupled together at a sixth coupling point, the fifth coupling point and the sixth coupling point being on a same side of the jelly roll structure as the first coupling point and the second coupling point.

13. The battery cell of claim 12, wherein the lead tabs are coupled to a first side of the jelly roll structure and wherein the first subset of foil tabs, the second subset of foil tabs, the third subset of foil tabs, and the fourth subset of foil tabs all extend from a second side of the jelly roll structure opposite the first side.

14. The battery cell of claim 10, wherein the multi-layer stack includes at least one separator layer interleaved between the anode layer and the cathode layer.

15. The battery cell of claim 10, wherein the first coupling point and the second coupling point are weld joints.

16. The battery cell of claim 10, wherein the lead tabs include:
a first lead tab coupled to the anode layer at a third coupling point, the first lead tab serving as a negative terminal of the battery cell; and
a second lead tab coupled to the cathode layer at a fourth coupling point, the second lead tab serving as a positive terminal of the battery cell.

17. The battery cell of claim 16, wherein the first lead tab is attached to the anode layer proximal to the first end of the multi-layer stack and the second lead tab is attached to the cathode layer proximal to the first end of the multi-layer stack.

18. The battery cell of claim 16, wherein the first lead tab is attached to a foil substrate at a first location that is substantially surrounded by a first active material and wherein the second lead tab is attached to a second foil substrate at a second location that is substantially surrounded by a second active material.

19. A battery cell including:
a jelly roll structure comprising a multi-layer stack coiled between a first end and a second end, the multi-layer stack including at least an anode layer and a cathode layer;
a first subset of foil tabs extending from the anode layer, the first subset of foil tabs being electrically coupled together;
a second subset of foil tabs extending from the cathode layer, the second subset of foil tabs being electrically coupled together; and
lead tabs serving as terminals of the lithium ion battery cell, the lead tabs extending from an end of the battery cell that is opposite the first subset of foil tabs and the second subset of foil tabs.

20. The battery cell of claim 19, wherein the first subset of foil tabs are adjoined at a first coupling point and the second subset of foil tabs are adjoined at a second coupling point and the battery cell further comprises:
a third subset of foil tabs extending from the anode layer, the third subset of foil tabs being electrically coupled together at third coupling point separate from the first coupling point; and
a fourth subset of foil tabs that extend from the cathode layer, the fourth subset of foil tabs being electrically coupled together at a fourth coupling point separate from the second coupling point.
